(19) United States
(12) Patent Application Publication
(10) Pub. No.: US 2006/0281838 A1
(43) Pub. Date: Dec. 14, 2006

(54) Non-provisional patent application

(76) Inventors: Thomas Steinhausler, Collierville, TN (US); Thomas J. Folda, Collierville, TN (US); John J. Young, Valparaiso, IN (US); Jeffrey L. Klipstein, Frankfort, IL (US); David W. Brown, Valparaiso, IN (US); William R. Gaines, Valparaiso, IN (US); Edward J. Kleese, Valparaiso, IN (US)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/448,212

(22) Filed: Jun. 7, 2006

Related U.S. Application Data
(60) Provisional application No. 60/688,659, filed on Jun. 8, 2005.

(51) Int. Cl. C08K 5/00

(52) U.S. Cl. 524/81; 264/319; 524/401

(57) ABSTRACT

Powder-coatable compositions for sheet and bulk molded products with a Class A surface after powder coating comprise an unsaturated polyester and/or vinyl ester, a monomer which is copolymerizable with the polyester and/or vinyl ester, at least two thermoplastic polymers, a filler and a reinforcing agent.

This application claims the benefit of U.S. Provisional Application Ser. No. 60/688,659, filed Jun. 8, 2005.

### TECHNICAL FIELD

The present invention relates to powder-coatable molding compositions. In a more specific aspect, this invention relates to such molding compositions which provide products with a Class A surface after powder coating. This invention also relates to a process for the manufacture of these powder-coatable molding compositions.

### BACKGROUND OF THE INVENTION

Molding compositions have been manufactured and used for many years in forming various articles. Examples of these compositions include sheet molding compositions (SMC) and bulk molding compositions (BMC).

Automotive painting operations are typically carried out on a body-in-white, which is the unpainted unitary body structure comprising body panels and structural components. The body structure is usually formed mostly of steel panels but may include polymer composite panels. The paint shop practice is well known for the steel portion of the body structure, as the steel portion is electrically conductive and, therefore, receives several coating layers for corrosion resistance, paint adhesion and painted surface finish quality.

The polymer composite panels do not respond to the coating procedure in the same way as the steel panels. For example, automotive painting operations often involve the separate application of a zinc phosphate base layer, an electrocoated liquid prime coat using water or an organic solvent, a liquid or powder primer surfacer layer, a liquid base color coat and a liquid or powder clear top coat.

Following each of the prime coat, primer surfacer and clear top coat applications, a baking step at temperatures of 250° F. or higher is generally used to cure or dry the new layer and to promote flow of the top coat films to a commercially acceptable finish for a vehicle. Such aggressive heating of the painted composites typically leads to “out-gassing”, which is the release of entrapped air, solvent, moisture, uncured chemicals and uncured polymer precursor materials from the somewhat porous composite substrate. Too often the result is an unsightly and unacceptable rough surface. Out-gassing was initially experienced with liquid primer surfacer paints at their 250° F. bake temperature. The occurrence of surface roughness with such paint systems has been reduced in some instances by the use of a specially formulated, electrically conductive polymer prime coat as a barrier coat after molding. This polymer prime coat on the composite surface may reduce out-gassing at that location.

However, the prior art molding compositions often experience problems with achieving excellent surfaces with powder primers on parts molded from sheet molding or bulk molding compositions. These problems can be attributed to the kind and amount of components contained in the SMC or BMC compositions.

Examples of prior art efforts to improve the surface of molding compositions after powder prime include U.S. Pat. Nos. 6,872,294 and 6,875,471, which describe that the quality of painted surfaces of polymeric articles is improved by depositing a coating of a metal such as zinc or zinc alloy on the surface of the article to be painted. The metal coated polymeric surface provides a good base for electrostatic deposition of either liquid or powder paint, and the metal surface prevents the formation of defects in the painted surface during heating of the article to dry or cure the paint film.

U.S. Pat. No. 6,843,945 describes in-mold coating of polymer composite parts for metallization and painting.

U.S. Pat. No. 4,039,714 describes pre-treatment of plastic materials for metal plating by conditioning their surface by a treatment with sulfur trioxide vapor or a material which contains sulfur trioxide.

All the processes mentioned above require some kind of pre-treatment of the composite surface before powder-painting to result in a Class A surface, which increases cycle-time and adds cost. Therefore, there is a need in the industry for molding compositions which will provide an excellent surface to the molded products and painted parts without pre-treatment steps.

### SUMMARY OF THE INVENTION

The present invention provides powder-coatable molding compositions for the manufacture of sheet molded products and bulk molded products which surprisingly have an excellent surface after powder prime and paint. The present invention also provides a process for the manufacture of these powder-coatable molding compositions.

Accordingly, an object of this invention is to provide powder-coatable molding compositions.

Another object of this invention is to provide powder-coatable molding compositions for sheet molded products and bulk molded products.

Another object of this invention is to provide powder-coatable molding compositions which, when molded and powder-primed, provide products with an excellent surface.

Still another object of this invention is to provide a process for the manufacture of powder-coatable molding compositions.

Still another object of this invention is to provide a process for the manufacture of powder-coatable molding compositions for sheet molded products and bulk molded products.

Still another object of this invention is to provide a process for the manufacture of molding compositions which, when molded and powder-primed, provide products with an excellent surface.

These and other objects, features and advantages of this invention will become apparent from the following detailed description.

### BRIEF DESCRIPTION OF THE DRAWINGS

FIG. 1 shows a digital image of the reflection of a fluorescent ceiling light on a powder primed panel made from a sheet molding composition of the prior art.

FIG. 2 shows a digital image of the reflection of a fluorescent ceiling light on a powder primed panel made from a sheet molding composition of this invention.

### DETAILED DESCRIPTION OF THE INVENTION

The present invention provides a new and unique thermosetting, powder-coatable molding composition which comprises the following components: an unsaturated, uncured, curable polyester and/or vinyl ester; a monomer which will copolymerize with the unsaturated polyester and/or vinyl ester; at least two thermoplastic polymers; a filler; and a reinforcing agent.

The present invention also provides a process for the manufacture of these new and unique powder-coatable molding compositions.

As used in this application, the term “new and unique” will be understood as referring to the resulting excellent surface of sheet and bulk molded products made from the compositions of this invention after powder coating, and the term “excellent surface” will be understood as referring to either a Class A surface which has a Loria less than about 85 or a near Class A surface which has a Loria less than about 150. (The Loria values are measured on a Loria™ surface analyzer from Ashland Chemical Company).

Of course, depending upon the intended use, the molding compositions of this invention may optionally contain other additives, such as dyes, pigments, thickening agents, viscosity reducers, inhibitors, peroxides, mold release agents, catalysts, etc.

The molding compositions of this invention can be molded into various products, including sheet and bulk parts, such as automotive hoods, fenders, truck beds, bumpers, etc.

The unsaturated, uncured, curable polyesters and/or vinyl esters useful in this invention are commercially available products. These polyesters (sometimes referred to as polyester alkyds) are a class of soluble, linear, low molecular weight materials which contain both carboxylic ester groups and carbon-carbon double bonds as recurring units along the main polymer chain. These polyesters may be prepared by condensation of long chain polyols, diols, ethylenically unsaturated dicarboxylic acids or anhydrides to impart the unsaturation and saturated dicarboxylic acids to modify the polymer.

Suitable unsaturated polyesters are the usual condensation products of polybasic acids, in particular dibasic carboxylic acids and their esterifiable derivatives such as their anhydrides, with polyhydric alcohols. Preferred unsaturated polyesters are those formed from maleic anhydride and propylene glycol; 1, 3-propanediol; 1, 4-butanediol; neopentyl glycol; ethylene glycol; diethylene glycol; dipropylene glycol and/or dicyclopentadiene.

Suitable vinyl ester resins, also known as epoxy (meth) acrylates, that may be used in the composition of this invention are addition products of polyepoxides and unsaturated carboxylic acids, preferably acrylic acid and methacrylic acid. Suitable polyepoxides are epoxy novolac resins and, in particular, polyepoxides based on bisphenol A. Another suitable class of vinyl ester resins is the esterification products of alkoxylated bisphenol A and (meth) acrylic acid.

The monomer used in this invention can be mono-or poly-functional but must be copolymerizable with the unsaturated polyester and/or vinyl ester. Preferred monomers are styrene, alpha-methyl styrene, chlorostyrene, vinyl toluene, divinyl benzene, methyl methacrylate and mixtures thereof.

A third essential part of the molding compositions of this invention is a blend (i.e., at least two) of thermoplastic polymers (also referred to as low profile additives). As with the unsaturated polyester, these thermoplastic polymers are commercially available products and are especially useful in producing molded articles having a Class A surface which is essential for molded automotive parts. Many thermoplastic polymers can be used in this invention, including saturated polyester alkyds, vinyl polymers, polymethacrylates, acrylic polymers and mixtures thereof. For purposes of this invention, rubber-containing homopolymers and copolymers shall be considered as thermoplastic polymers. Preferred thermoplastic polymers are poly(methylmethacrylate), styrene-butadiene-copolymers, saturated polyester alkyds and mixtures thereof.

In this invention, the thermoplastic polymer component is present in amount of from about 10 to about 25 percent by weight, based on the total weight of the unsaturated polyester and/or vinyl ester component, the monomer component and the thermoplastic polymer component.

The low profile additive most commonly used in the industry, a vinyl acetate containing polymer, is not a preferred thermoplastic polymer to make the compositions of this invention. However, a low amount of a vinyl acetate containing polymer, such as no more than about 5.0 percent by weight, may be used to increase surface smoothness of the molded part.

The molding compositions of this invention also contain a reinforcing agent. Specific suitable reinforcing agents are made from glass, carbon and synthetic organic fibers such as polyethylene, polycarboxylic esters, polycarbonates and mixtures thereof.

Our molding compositions also contain a filler. Preferred fillers are alumina trihydrate, alumina powder, aluminosilicate, baruim sulfate, calcium carbonate, calcium silicate, calcium sulfate, clay, dolomite, glass spheres, limestone dust, mica, quartz powder, crushed silica, talc and mixtures thereof.

Other additives may also be used in formulating the curable resin composition of the present invention. The additives and their functions are well known in the industry, examples of which are tougheners, release agents, inhibitors, leveling agents, wetting agents and adhesion promoters.

Examples of suitable compatibilizers are leveling agents (such as acrylic resins, fluorocarbons, fluoropolymers and silicones) and wetting agents (such as boric acid esters, phosphate esters, fatty acid salts and polyethers).

The composition may also contain conventional toughening agents such as core shell rubbers or liquid rubbers having reactive groups.

Suitable inhibitors are phenolic compounds such as (substituted) hydroquinone, pyrocatechol, t-butylpyrocatechol and ring-substituted pyrocatechols; quinones such as benzoquinone, naphthoquinone and chloranil; nitrobenzenes such as m-dinitrobenzene and thiodiphenylamine; N-nitroso compounds such as N-nitrosodiphenylamine; salts of N-nitroso-N-cyclohexylhydroxylamine; and mixtures thereof.

Suitable thickeners include oxides or hydroxides of lithium, magnesium, calcium, aluminium or titantium. Preferred thickeners include magnesium oxide and magnesium hydroxide.

The resin compositions of this invention may be cured by a number of free- radical initiators, such as organic peroxide and azo-type initiators. Peroxide initiators include diacylperoxides, hydroperoxides, ketone peroxides, peroxyesters, peroxyketals, dialkyl peroxides, alkyl peresters and percarbonates. Azo-type initiators include azobisisobutyronitrile and related compounds. These initiators are preferably used in the range of from about 1 to about 3 percent by weight.

Other optional additives are mold release agents, such as zinc stearate, magnesium stearate and calcium stearate; curing accelerants such as octoates or naphthenates of copper, lead, calcium, magnesium, cerium, manganese and cobalt; and thickening accelerants such as water and polyols.

The composition of this invention can be used to mold various parts which, after cure, exhibit a change of from about 0.02 percent shrinkage to about 0.07 percent expansion, as compared to cold mold dimensions.

The present invention is further illustrated by the following example which is illustrative of certain embodiments designed to teach those of ordinary skill in the art how to practice this invention and to represent the best mode contemplated for carrying out this invention.

### EXAMPLE

A process for making a SMC is described as follows. All ingredients, except for the glass, fiber strands are mixed together to form a resin paste. The paste is transferred to a doctor box and then deposited onto a moving carrier film passing directly beneath. At the same time, glass fiber strands are fed into a cutting apparatus above the resin paste coated carrier film. The fibers are chopped to 1 inch length and dropped onto the resin paste. The amount of glass is controlled by the speeds of the cutter and the carrier film. After the glass deposition, a second resin paste coated carrier film is laid on top, paste side down. The paste-glass-paste sandwich is subsequently sent through a series of compaction rollers where the fibers are wet out with the paste and excess trapped air is squeezed out of the sheet. At the end of the compaction rollers, the SMC sheet is bi-folded into a bin which is covered tightly to avoid the evaporation of styrene and other ingredients.

Before used for molding, the SMC must mature. The maturation is required to allow the relatively low-viscosity resin to thicken chemically and also increase significantly in viscosity. The thickened SMC is easier to handle and prevents the resin paste from being squeezed out of the glass fiber bed. SMC typically requires 3 to 5 days to reach the desired molding viscosity (˜40 to 100 million mPa·s).

When the SMC is ready for molding, the sheet is cut into pieces of a predetermined size and shape, and the carrier film on both sides removed. The pieces are then placed on the hot mold surface in a pattern that was established earlier for optimum flow and mold coverage during compression. Under heat and pressure, the SMC flows to fill the mold cavity. The cure time of the SMC varies from 30 to 150 seconds, depending mostly on the material formulation and the thickness of the molded part.

After curing, the mold is opened, and the part is ejected from the bottom mold surface with the use of ejector pins. Care must be used during removal of the part from the press to avoid stressing of the part.

The molded parts are then sent to the painting operation where the parts are powder primed to customer specifications.

The following Tables 1-3 are used for comparison purposes. Table 1 illustrates a standard Tough Class A (“TCA”) SMC formulation (as described in U.S. Pat. No. 6,759,466) which is widely used in the industry for the manufacture of composite automotive body panels because of the ability of this formulation to significantly reduce paint pops. Table 2 illustrates a Class A SMC formulation with a low profile additive package containing poly (vinyl acetate). Table 3 illustrates a Class A SMC formulation according to this invention which uses a for powder-prime surface optimized low profile additive package.

All 3 SMC formulations contain 27.5% by weight 1 inch glass fibers as a reinforcing agent, and all 3 SMC formulations show a Class A capable surface (30-85 Loria), after demolding from the press before powder prime.

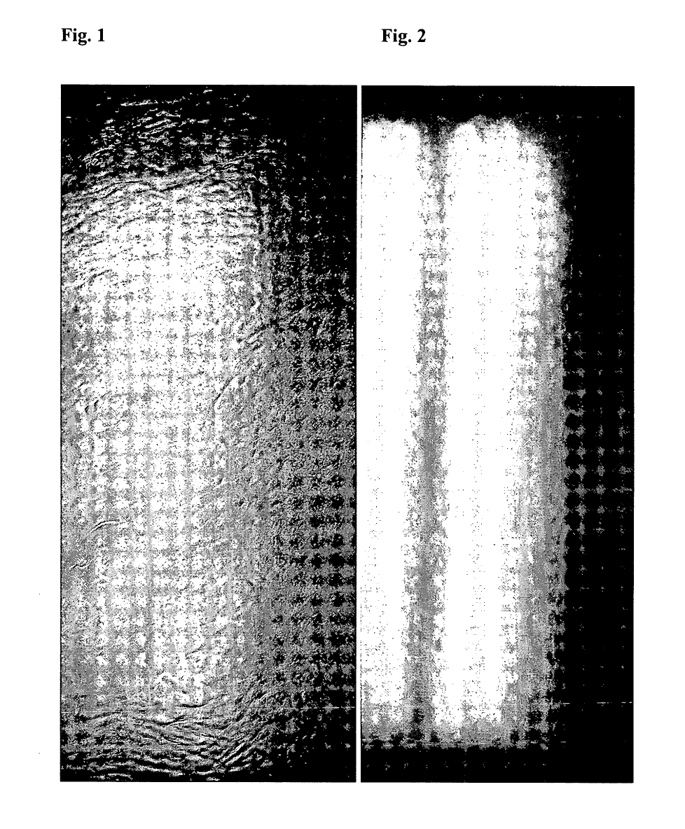

FIGS. 1 and 2 show digital images of sections of panels of the formulations of Tables 1 and 3 after powder prime. Both images cover the same area on the respective panels and are of identical resolution. The composition described in Table 3 (FIG. 2) clearly outperformed the standard TCA system (FIG. 1). The term PHR refers to parts per hundred resin, and the term resin refers to the sum of all polymers, polyester alkyds and reactive monomers in the composition.

In terms of grades, the powder primed parts from the composition in Table 3 would be considered an A (highest grade), the parts from the composition in Table 2 would be a D and the parts from the composition in Table 1 would be an F.

TABLE 1

| Material | PHR | grams |
|---|---|---|
| Unsaturated Polyester Alkyd | 32.1 | 1992 |
| Saturated Polyester Alkyd | 13.9 | 859 |
| Acrylic Polymer | 3.4 | 211 |
| Styrene | 40.4 | 2521 |
| Divinylbenzene | 5.4 | 335 |
| Compatibilizer | 5.6 | 347 |
| Toughener | 2.0 | 121 |
| Inhibitor Solution | 0.8 | 50 |
| Catalyst | 1.8 | 112 |
| Mold Release | 4.0 | 248 |
| Calcium Carbonate Filler | 200.0 | 12400 |
| Thickener B-side | 8.5 | 527 |

TABLE 2

| Material | PHR | grams |
|---|---|---|
| Unsaturated Polyester Alkyd | 32.8 | 2031 |
| Styrene-Butadiene Copolymer | 7.4 | 457 |
| Acrylic Polymer | 2.7 | 166 |
| Saturated Polyester Alkyd | 4.4 | 271 |
| Vinyl Acetate Polymer | 4.0 | 248 |
| Styrene | 46.4 | 2875 |
| Compatibilizer | 3.0 | 187 |
| Catalyst | 1.8 | 112 |
| Inhibitor Solution | 0.3 | 19 |
| Mold Release | 4.2 | 260 |
| Calcium Carbonate Filler | 200.0 | 12400 |
| Thickener B-side | 10.0 | 620 |

TABLE 3

| Material | PHR | grams |
|---|---|---|
| Unsaturated Polyester Alkyd | 32.8 | 2031 |
| Styrene-Butadiene Copolymer | 9.1 | 564 |
| Acrylic Polymer | 3.3 | 205 |
| Saturated Polyester Alkyd | 5.4 | 334 |
| Styrene | 46.4 | 2875 |
| Compatibilizer | 3.0 | 187 |
| Catalyst | 1.8 | 112 |
| Inhibitor Solution | 0.3 | 19 |
| Mold Release | 4.2 | 260 |
| Calcium Carbonate Filler | 190.0 | 11780 |
| Thickener B-side | 10.2 | 632 |

This invention has been described in detail with particular reference to certain embodiments, but variations and modifications can be made without departing from the spirit and scope of the invention as defined in the following claims.

What is claimed is:

1. A thermosetting, powder-coatable molding composition which comprises the following components:
A. an unsaturated, uncured, curable polyester, vinyl ester or blend thereof;
B. a monomer which will copolymerize with the unsaturated polyester, vinyl ester or blend thereof;
C. at least two thermoplastic polymers;
D. a filler; and
E. a reinforcing agent,
wherein a product molded from the composition has an excellent surface with a Loria of about 30 to about 85 before powder coating and a Loria of less than about 150 after powder coating.

2. A molding composition as defined by claim 1 wherein the thermoplastic polymer component is a blend of an acrylic polymer and a styrene-butadiene copolymer.

3. A molding composition as defined by claim 1 wherein the composition contains from about 10 to about 25 percent of the thermoplastic polymer component based on the total weight of components A, B and C.

4. A molding composition as defined by claim 1 wherein the composition contains less than about 10 percent of a saturated polyester alkyd based on the total weight of components A, B and C.

5. A molding composition as defined by claim 1 wherein the composition contains less than about 5 percent of a vinyl acetate containing polymer based on the total weight of components A, B and C.

6. A molding composition as defined by claim 1 wherein the composition contains less than about 10 percent of a saturated polyester alkyd and a vinyl acetate containing polymer based on of the total weight of components A, B and C.

7. A molding composition as defined in claim 1 wherein the volumetric change during cure of the composition is from about 0.02 percent shrinkage to about 0.07 percent expansion.

8. A process for the manufacture of a powder-coatable, cured, thermosetting molding composition for use in the manufacture of molded products which have excellent surface, wherein the process comprises the steps of mixing the following components:
A. an unsaturated, uncured, curable polyester, vinyl ester or blend thereof;
B. a monomer which will copolymerize with the unsaturated polyester, vinyl ester or blend thereof;
C. at least two thermoplastic polymers;
D. a filler; and
E. a reinforcing agent,
and curing the composition in a heated compression mold at a temperature above 80° C.

9. A process as defined by claim 8 wherein the temperature of the mold is from about 130 to about 180° C.

10. A process as defined by claim 8 wherein the mold is under a pressure of from about 50 to about 1500 psi.

11. A process as defined by claim 8 wherein the thermoplastic polymer component is a blend of an acrylic polymer and a styrene-butadiene copolymer.

12. A process as defined by claim 8 wherein the composition contains from about 10 to about 25 percent of the thermoplastic polymer component based on the total weight of components A, B and C.

13. A process as defined by claim 8 wherein the composition contains less than about 10 percent of a saturated polyester alkyd based on the total weight of components A, B and C.

14. A process as defined by claim 8 wherein the composition contains less than about 5 percent of a vinyl acetate containing polymer based on the total weight of components A, B and C.

15. A process as defined by claim 8 wherein the composition contains less than about 10 percent of a saturated polyester alkyd and a vinyl acetate containing polymer based on the total weight of components A, B and C.

16. A process as defined in claim 8 wherein the volumetric change during cure of the composition is from about 0.02 percent shrinkage to about 0.07 percent expansion.
